(19) United States
(12) Patent Application Publication
(10) Pub. No.: US 2014/0078489 A1
(43) Pub. Date: Mar. 20, 2014

(54) OPTICAL RADAR DEVICE

(71) Applicant: Denso Corporation, Kariya-city (JP)

(72) Inventor: Yoshiaki HOASHI, Kariya-city (JP)

(73) Assignee: DENSO CORPORATION, Kariya-city (JP)

(21) Appl. No.: 14/028,765

(22) Filed: Sep. 17, 2013

(30) Foreign Application Priority Data
Sep. 18, 2012 (JP) 2012-204415

(51) Int. Cl. G01S 7/481

(52) U.S. Cl. CPC G01S 7/481
USPC 356/4.01

(57) ABSTRACT

An optical laser device for scanning an object is provided. The optical radar device includes a light source that outputs a beam having an elliptical cross section. The beam is output towards a light scanning section that rotates a mirror plate about an axis for (i) reflecting the beam toward the object and (ii) reflecting a reflected light received from the object. The device also includes a light path change section that guides the beam toward the light scanning section and guides the reflected light from the light scanning section in a direction that is different from a direction of the light source. A light receiver receives the reflected light. Further, the elliptical cross section of the beam has a major axis and the major axis is substantially parallel to the axis of the mirror plate.

### CROSS-REFERENCE TO RELATED APPLICATION

This application is based on and claims the benefit of priority of Japanese Patent Application No. 2012-204415 filed on Sep. 18, 2012, the disclosure of which is incorporated herein by reference.

### TECHNICAL FIELD

The present disclosure generally relates to an optical radar device which scans an object by projecting a light toward the object and receiving a reflected light that is reflected from the object.

### BACKGROUND

Conventionally, an object may be scanned by projecting a pulse laser beam at the object. A reflected laser beam from the scanned object is received to obtain information regarding the scanned object. Such an optical radar device is disclosed in, for example, a patent document 1 (i.e., Japanese Patent Laid-Open No. JP-A-2001-208846).

An object may be scanned with a pulse laser beam that is reflected using a mirror plate. The mirror plate may be rotated within a certain range in order to scanningly project the laser beam (i.e., for changing a projection direction of the laser beam).

Generally, it is desirable to reduce the size and volume of the optical radar device. However, reducing the size and volume of the device may be difficult because of the size of the mirror plate. More specifically, the mirror plate must be sufficiently sized to reflect the entire laser beam. Further, the laser beam may have an elliptical shape with a long and narrow cross section. Therefore, the mirror plate may be larger in size thereby making it difficult to reduce the volume of the optical radar device.

### SUMMARY

It is an object of the present disclosure to provide an optical radar device having a smaller size and volume.

In an aspect of the present disclosure, the optical radar device for scanning an object includes a light source that outputs a beam having an elliptical cross section. The device also includes a light scanning section that rotates a mirror plate about an axis for (i) reflecting the beam toward the object and (ii) reflecting a reflected light received from the object. Further, the device has a light path change section that guides the beam toward the light scanning section and guides the reflected light reflected by the light scanning section in a direction that is different from a direction of the light source. Additionally, the device has a light receiver that receives the reflected light. Further, the elliptical cross section of the beam has a major axis and the major axis is substantially parallel to the axis of the mirror plate.

In the optical radar device of the present disclosure, the beam has an elliptical cross section and an angle between a major axis of the beam and an axis of the mirror plate that is less than or equal to 30 degrees, for example. In other words, the major axis of the elliptical beam and the shaft of the mirror plate are substantially parallel. By devising such structure, the size of the mirror plate is reduced.

### BRIEF DESCRIPTION OF THE DRAWINGS

Other objects, features and advantages of the present disclosure will become more apparent from the following detailed description disposed with reference to the accompanying drawings, in which:

FIG. 1 is a side view of an optical radar device;

FIG. 2 is a top view of the optical radar device;

FIG. 3 is a perspective view of the configuration of a light source;

FIG. 4A is a graph illustrating the light distribution of a beam;

FIG. 4B is a graph illustrating the light distribution of the beam;

FIG. 5A is a side view of a mirror plate; and

FIG. 5B is an explanatory view illustrating a positional relationship between the mirror plate, a beam area, a diameter of the beam area, and a shaft.

### DETAILED DESCRIPTION

An embodiment of the present disclosure is described based on the drawings.

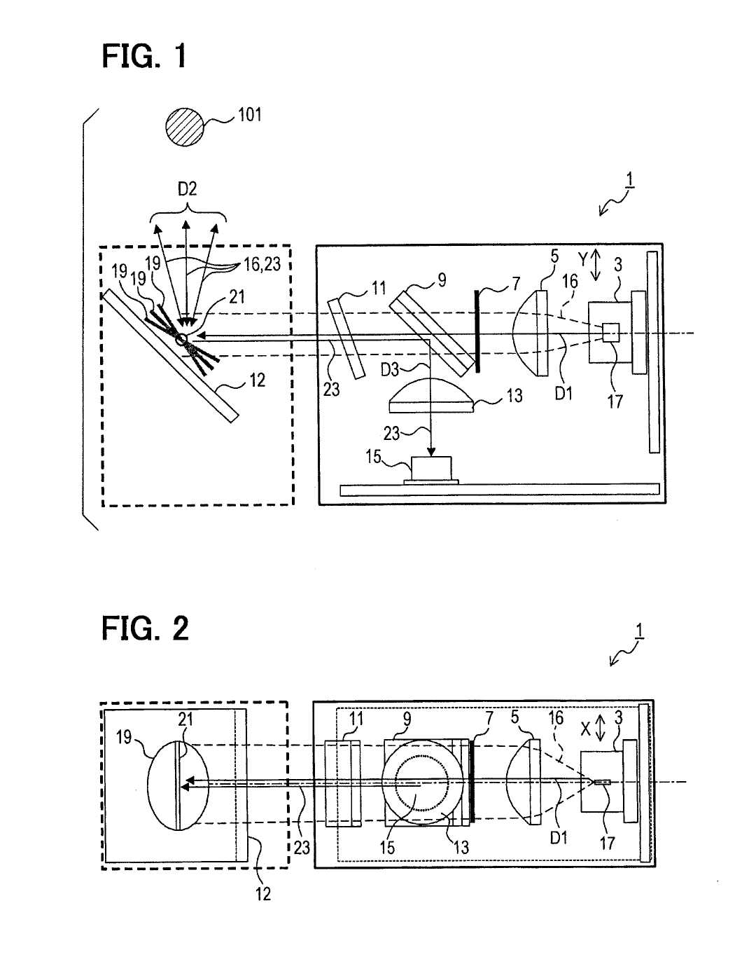

Referring to FIGS. 1 to 4, a configuration of an optical radar device 1 is provided. The optical radar device 1 is an onboard vehicular device. The optical radar device 1 includes a light source 3, a collimate lens 5, an aperture 7, a polarized beam splitter (i.e., a light path change section) 9, a λ/4 board (i.e., a ¼ wave length plate) 11, a light scanning section 12, a light receiving lens 13, and a light receiver 15.

The light source 3 emits/outputs a laser beam 16 (i.e., a pulse laser beam) from an edge emitting type laser diode (LD) 17 in an output-light-proceeding direction D1, as shown in FIGS. 1 and 2.

The light has an elliptical cross section (i.e., the cross sectional shape of the beam 16 emitted from the laser diode 17, when taken along a plane perpendicular to the output-light-proceeding direction D1, is elliptical). The shape of the light is defined as a shape of an area in which an intensity of the light exceeds a certain threshold. The light may have a shape other than an elliptical shape, such as a rectangle or the like, so that the shape has both long and short axes.

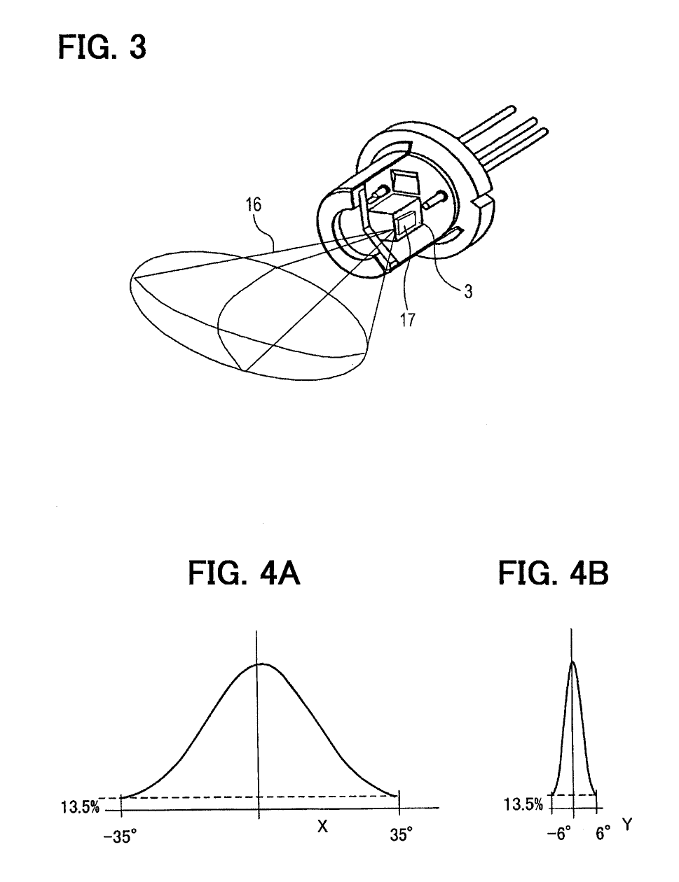

As illustrated in FIGS. 1 and 2, a major axis of the elliptical cross section of the beam 16 is perpendicular to the output-light-proceeding direction D1. The major axis direction is hereinafter designated as an X direction, as shown in FIG. 2. Similarly, a minor axis of the elliptical cross section of the beam 16 is also perpendicular to the output-light-proceeding direction D1. The short axis direction is hereinafter designated as a Y direction, as shown in FIG. 1. The shape of the beam 16 which is emitted by the laser diode 17 is shown in FIG. 3 and in FIGS. 4A and 4B. As shown in FIGS. 4A and B, the beam 16 is wider along the X direction and narrower along the Y direction. The beam 16 is also linearly-polarized in a specified polarization direction α.

The collimate lens 5 is disposed at a position in the output-light-proceeding direction D1 relative to the light source 3. The collimate lens 5 narrows and aligns the beam 16 into a parallel light.

The aperture 7 is disposed at a position in the output-light-proceeding direction D1 relative to the collimate lens 5. The aperture 7 cuts/narrows the width of the beam 16 into a preset range.

The polarized beam splitter 9 is disposed at a position in the output-light-proceeding direction D1 relative to the aperture 7, and is angled at 45 degrees relative to the output-light-proceeding direction D1. The polarized beam splitter 9 is a device that allows linearly-polarized light polarized in the polarization direction α to pass therethrough, and reflects light that is polarized in other directions. As mentioned above, since the beam 16 is linearly-polarized in the polarization direction α, the polarized beam splitter 9 allows the beam 16 to pass therethrough, and guides the beam 16 in a direction toward the light scanning section 12. Further, since the polarization direction of a reflected light 23 to be mentioned later is shifted by 90 degrees against the polarization direction α, the reflected light 23 is reflected by the polarized beam splitter 9 in a reflected-light-proceeding direction D3 (i.e., a different direction that is different from the direction toward the light source 3).

The λ/4 board 11 is positioned in the output-light-proceeding direction D1 relative to the polarized beam splitter 9, and is angled relative to the output-light-proceeding direction D1. The λ/4 board 11 converts the linearly-polarized light into a circularly-polarized light, and also converts the circularly-polarized light into the linearly-polarized light. Therefore, the λ/4 board 11 converts the beam 16 into the circularly-polarized light, and converts the reflected light 23 to be mentioned later into the linearly-polarized light. Further, the polarization direction of the reflected light 23 that has been converted into the linearly-polarized light is shifted by 90 degrees against the polarization direction of the beam 16 (i.e., the polarization direction before the conversion into the circularly-polarized light).

The light scanning section 12 is disposed at a position in the output-light-proceeding direction D1 relative to the λ/4 board 11. The light scanning section 12 has a circular mirror plate 19 which has a mirror surface formed on one side. The circular mirror plate 19 is rotatably disposed about a shaft 21. The light scanning section 12 may have a motor (not shown) that rotates the shaft 21 to rotate the mirror plate 19. The shaft 21 is positioned along a center of the mirror plate 19 and is parallel to the mirror surface of the mirror plate 19. As illustrated in FIG. 2, the direction of the shaft 21 is aligned in the above-mentioned X direction. The mirror plate 19 may have a range of rotation of approximately 60 degrees. As illustrated in FIG. 1, the range of rotation of the mirror plate 19 relative to the output-light-proceeding direction D1 may be between 15 to 75 degrees.

The mirror plate 19 reflects the beam 16 in a reflecting direction D2. The reflecting direction D2 may change according to the angle and rotating movements of the mirror plate 19. That is, the beam 16 is output in a scanningly rotated manner by the angle change of the mirror plate 19.

The mirror plate 19 of the light scanning section 12 may also be rotated about another axis (not illustrated) that is perpendicular to the shaft 21, which allows two-dimensional scanning of an object by using the beam 16.

After proceeding in the reflecting direction D2 and being reflected by an object 101, the reflected light of the beam 16 returns to the mirror plate 19 and is reflected by the mirror plate 19 to be guided in a direction toward the λ/4 board 11. The reflected light 23 is circularly-polarized.

The light receiving lens 13 is disposed at a position in the reflected-light-proceeding direction D3 relative to the polarized beam splitter 9 (i.e., at a position in a light path of the reflected light 23). The light receiving lens 13 converges the reflected light 23.

The light receiver 15 is disposed at a position in the reflected-light-proceeding direction D3 relative to the light receiving lens 13. The light receiver 15 may include a photo diode (PD) for detecting the reflected light 23.

2. Process Performed by the Optical Radar Device 1

The following description is in regards to a process performed by the optical radar device 1. The light source 3 emits the beam 16 in the output-light-proceeding direction D1. The beam 16 is converted into a parallel light by the collimate lens 5, narrowed by the aperture 7, passes the polarized beam splitter 9, and is converted into the circularly-polarized light by the λ/4 board 11. The beam 16 converted into the circularly-polarized light is used by the light scanning section 12 to scan the object 101. The beam 16 is then reflected by the object 101 and generates the reflected light 23.

Then, the reflected light 23 from the object 101 is reflected into the direction of the λ/4 board 11 by the mirror plate 19 of the light scanning section 12, and converted into the linearly-polarized light by the λ/4 board 11. The polarization direction of the reflected light 23 that has been converted back into the linearly-polarized light has a shift of 90 degrees relative to the polarization direction α of the beam 16 (i.e., the polarization direction before the conversion into the circularly-polarized light). The reflected light 23, which has passed through the λ/4 board 11, is reflected into the reflected-light-proceeding direction D3 by the polarized beam splitter 9, is converged by passing through the light receiving lens 13, and detected by the light receiver 15.

Then, a distance to the object 101 is computed based on a time difference between (i) a time when the light source 3 output the beam 16 and (ii) a time when the light receiver 15 detected the reflected light 23.

3. Resultant Effects of the Optical Radar Device 1

(1) In the optical radar device 1, the major axis of the cross section of the beam 16 and the direction of the shaft 21 (i.e., the X direction) are in parallel with each other (i.e., an angle between them is equal to 0 degree). Therefore, even when the mirror plate 19 covers an entire beam 16, the size of the mirror plate 19 is reduced.

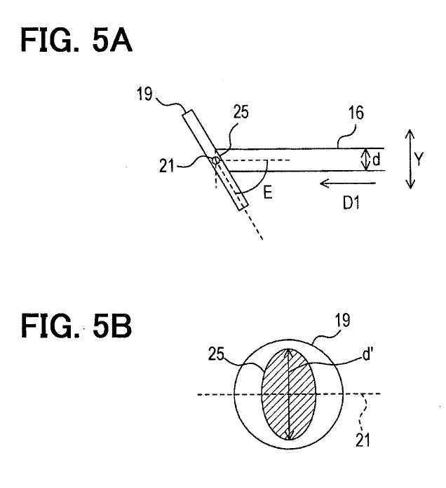

The reasoning of the above is more practically explained based on FIGS. 5A and 5B. The mirror plate 19 is angled relative to the output-light-proceeding direction D1 by an angle of 15 to 75 degrees (i.e., an angle E). Therefore, when a diameter d is defined as a Y direction diameter of the beam 16, as shown in FIG. 5A, and an area 25 is defined as a projection area of the beam 16 on the mirror plate 19, as shown in FIGS. 5A and 5B, a diameter d′ of the area 25 on the plate 19 defined as perpendicular to the shaft 21 is computed as d/sin(E), which is larger than the diameter d. Therefore, the diameter of the mirror plate 19 should be equal to or greater than the diameter d′ in order for the mirror plate 19 to cover (i.e., mirror/reflect) the area 25 in its entirety.

In the above-mentioned embodiment and as shown in FIG. 2, the major axis of the cross section of the beam 16 is aligned with (i.e., in parallel with) the X direction. However, the major axis direction of the cross section of the beam 16 may be oriented in a direction other than the X direction (not illustrated). For example, the major axis of the beam may be angled relative to the X direction. With such a configuration, the diameter d in FIG. 5A and the diameter d′ in FIG. 5B may be further reduced, thereby further reducing the size of the mirror plate 19.

(2) The λ/4 board 11 is not disposed at an orthogonal angle relative to the output-light-proceeding direction D1, that is, the λ/4 board 11 is angled relative to the direction D1. Therefore, the noise from the light reflected by the λ/4 board 11 and received by the light receiver 15 may be reduced.

Although the present disclosure has been fully described in connection with the above embodiment thereof with reference to the accompanying drawings, it is to be noted that various converts and modifications will become apparent to those skilled in the art.

For example, the major axis of the cross section of the beam 16 and the direction of the shaft 21 may be arranged at other angles, such as an angle of 0 to 30 degrees, an angle of 0 to 15 degrees, or an angle of 0 to 5 degrees. Even in such cases, the above-described diameters d and d′ are respectively made relatively smaller, thereby reducing the size of the mirror plate 19.

The polarized beam splitter 9 may be a plate type splitter, or may be a cube type splitter.

Such changes and modifications are to be understood as being within the scope of the present disclosure as defined by the appended claims.

What is claimed is:

1. An optical radar device for scanning an object comprising:
a light source outputting a beam having an elliptical cross section;
a light scanning section rotating a mirror plate about an axis to (i) reflect the beam toward the object and (ii) reflect a reflected light received from the object;
a light path change section guiding the beam toward the light scanning section and guiding the reflected light reflected by the light scanning section in a direction that is different from a light source direction; and
a light receiver receiving the reflected light, wherein
the elliptical cross section of the beam has a major axis and the major axis is substantially parallel to the axis of the mirror plate.

2. The optical radar device of claim 1, wherein
the light source outputs the beam from an edge emitting type laser diode.

3. The optical radar device of claim 1, wherein
the light path change section is a polarized light beam splitter, and
the light path change section and the light scanning section are interposed by a λ/4 board.
